(19) United States
(12) Patent Application Publication
(10) Pub. No.: US 2008/0131220 A1
(43) Pub. Date: Jun. 5, 2008

(54) Suction Device Associated With The Tool Of A Cutting Machine Tool

(76) Inventor: André Azema, Saix (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 10/595,679

(22) PCT Filed: Nov. 3, 2004
(86) PCT No.: PCT/FR04/50558

§ 371 Date: Dec. 20, 2006

(30) Foreign Application Priority Data
Nov. 5, 2003 (FR) 0312985

(51) Int. Cl. B23Q 11/00

(52) U.S. Cl. 408/58

(57) ABSTRACT

The invention relates to a device (D) for removing by suction chips produced by a cutting machine tool by means of at least one tool (200) actuated by a tool holder module comprising a suction unit forming a low pressure. The tool (200) consists of a cutting part (210) and a standard fixing support (220). The inventive device is characterised in that it is provided with an suction hood (100) which is flexibly connected to said standard fixing support (220) of the tool (200) in such a way that a low pressure is produced around said tool (200) up to the end thereof and is fixedly and accurately connected to the tool holder module in such a way that the suction hood (100) is positioned with respect to the tool (200) forming a space therebetween, thereby enabling the tool to rotate with respect to the hood. Said invention is used for removing chips and fluids produced during a cutting process.

### FIELD OF THE INVENTION

The present invention relates to the field of machining and notably to adaptations enabling evacuation under optimal conditions of the shavings produced by the machining operation.

### DESCRIPTION OF THE PRIOR ART

The exhaust of shavings produced by the machining operation is a constant concern of machine tool designers.

As it happens, the evolution of environmental standards motivates the machining machine tool designers to limit the use of fluids for lubrication, exhaust, or cooling.

One of the lubrification techniques comprises replacing the traditional spraying of cutting fluid by micro-pulverization of the liquid by means of conduits laid out in the tool itself. As this technique does not enable exhaust of the shavings it is planned to associate it with a suction module.

It was determined that, in the context of an application with micro-pulverization, it was particularly important to carry out the suction as close as possible to the zone where the shavings are created, i.e. to use the suction devices incorporated with the tool, enabling the exhaust of the created effluents as they are produced.

One of these incorporated suction devices is described in the American document number U.S. Pat. No. 5,791,842, which proposes a device for suction and removal of shavings for the machining machine tool including a structure for automatic changing of the tool. This suction device for shaving products produced by the machining tool with means for at least a tool actuated by a tool holder module, is of the type including a unit for suction creating a low pressure, the tool being composed of a part for cutting and for attachment support. This device includes a suction conduit that, coupled to the suction unit, is fixed
by a pivot coupling with a standard tool attachment support in a manner to create a low pressure around the tool up to its end while permitting the rotation of the latter, and
in a manner fixed to the tool holder module.

The conduit is constituted on a part at the rear of a sleeve concentrically placed about the rotational axis of the tool on its standard attachment support by means of the coupling pivot. The housing is interiorly laid out in a manner to receive the exterior ring of rolling providing a pivot coupling between the conduit and the standard attachment support of the tool and of which the interior ring is fixed on a surface provided to this end on the attachment support of the tool. The rolling is fixed on the forward part of the tool attachment support, which is preformed from a cylindrical surface, from a shoulder and from a threading to provide the setting in position and maintenance in position of the aforementioned rolling. The aforementioned conduit integral with the tool is coupled to the latter, by the actuating module of the tool, which includes a receiving means for a part of the conduit having the function of coupling it to the suction unit. The aforementioned conduit integral with the tool is set in place on the tool holder module during the relative movement of the tool with respect to the tool holder module corresponding to that known for the intake of the tool into the aforementioned tool holder module without supplemental action. The aforementioned conduit includes a conduit end cooperating, once the tool is set in place in its actuation module, with a conduit end coupled to the means of setting in position and maintaining in position. The tool holder module that also receives the conduit is equipped with a common fixed adaptor that is placed opposing a corresponding incorporated adaptor of the conduit during the taking of the tool by the tool holder module, this fixed adaptor being equipped with an end of the conduit intended to be connected to the suction unit. In the device proposed by this document, the positioning of the conduit with respect to the tool is therefore realized by a pivot coupling implemented by rollings.

Another device is proposed in the European document number EP 0 955 125, which describes a cutting tool for a machine tool such as a milling tool, which includes a mobile body in rotation and a plurality of cutting surfaces mounted on the body of the tool.

The cutting tool includes a means for recuperating the shavings surrounding and enveloping the cutting edges of the cutting surfaces carried by the body of the rotating tool in order to recuperate the shavings generated by the machining operation. The means of recuperating includes an exhaust opening connectable to suction means to promote the exhaust of the shavings. The conduit providing the envelopment of the milling tool is coupled to a suction conduit and is pivotally coupled to the body of the tool, the pivot coupling being implemented by ball bearings. Consequently, the positioning of the conduit with respect to the tool is also realized in this document by a pivot coupling implemented by rollings.

### DESCRIPTION OF THE INVENTION

Given this situation, the applicant conducted research studies aiming to obviate the disadvantages of the prior art by proposing a technological solution enabling the installation of a suction module with the tool i.e. a suction devices for the shavings produced by the machining machine tool with at least a tool actuated by a tool holder module, the device being of the type including a suction unit generating a low pressure, the tool being composed of a cutting part and a standard support attachment.

A criterion that the applicant set resides in the simplicity and the low cost of the implementation of the envisioned solution. In fact, the incorporated part of the suction module must be the simplest possible because its cost is multiplied by the number of tools that are subject to be received by the machining machine tool. In fact, the use choice in the solutions described in the prior art one or several rollers, besides a single cost of this component, requires the presence of receiving surfaces for the latter as well as arrangements providing the setting in position and maintenance in position. The mounting of the rollings notably requires particular cylindrical surfaces for forming an accurate adjustment with the shaft and the cylinder to which it is coupled. The coupling being realized between the tool and the bus, the attachment support of the tool must be specific or to make the object of substantial modifications. This implementation multiplied by the number of tools is particularly heavy.

According to the principal feature of the invention, the device includes a suction conduit. It includes a suction conduit that is coupled
in a floating manner to the standard attachment support of the tool in a manner to generate a low pressure around the tool up to its end, and
in a manner fixed and precise, to the tool holder module in a manner to position the conduit with respect to the tool by creating a play between the conduit and the tool and to thus enable the rotation of the tool with respect to the conduit.

This device offers to individually envelope each tool with a sleeve or impermeable conduit that automatically connects itself on the common fixed subassembly on the module or the tool holding pin of the machine tool, during the taking of a tool. A flow of air is then maintained from the end of the work tool toward the tool holder module to suck the generated effluents. By coming into contact with the piece to be machined this conduit provides the confinement of the flow of air in a volume defined by the piece to be machined, the exterior surfaces of the tool, and the interior surfaces of the conduit.

The tool holder module can be constituted by a simple tool holding pin providing it only rotational actuation or alternatively by a ram capable of offering a plurality of additional movements.

Thus, in the context of the implementation of the device of the invention, each tool incorporates a suction conduit that follows the movements of the tool not only during the machining phases but also during the phases of changing of tools, being understood that this conduit cannot play its role as incorporated suction module except once it is installed on the tool holder module and in the machining phase. In accordance with the invention, the conduit is accurately positioned with respect to the tool only when the latter is fixed on it actuation module. This positioning comprises allowing a play between turning surfaces (tool and body of the tool) and the fixed surfaces (conduit). When the tool is not installed in the actuation means, the “floating” mounted conduit is not accurately positioned with respect to the tool but is only retained held by it. Thus, the means for setting in position and maintaining in position associated with the tool actuation module has not only the function of coupling the conduit to the suction unit as allowed for in the prior art documents, but also to realize the function of the positioning of the “floating” mounted conduit with respect to the turning tool in a manner to not interfere with this rotation. In fact, the absence of this functionality associated with the absence of guiding, would make impossible the machining operation with the conduit sporadically in contact (by shock) with the turning element.

This feature is furthermore particularly advantageous in that it allows for the floating fixation of the suction means to the standard attachment supporting each tool. The applicant oriented itself toward a technological solution simplifying the coupling between the incorporated suction conduit and the tool by mounting it floating it on the tool and by transferring the necessary positioning function between the conduit and the tool in the coupling between the conduit and the tool holder module. The adjective floating has here a meaning of defining that which is not fixedly attached and that has a relative freedom of movements. Thus, contrary to the solutions of the prior art that propose an rotational guidance carried out by rollers between the conduit and the tool, which defines a single degree of freedom in rotation according to the rotational axis of the tool, the applicant proposes to not provide the coupling between the tool and the conduit while limiting the amplitude of the movements of the conduit with respect to the tool. Consequently, the coupling carried out by the invention between the conduit and the tool allows the six degrees of freedom.

On of the concerns of the applicant in the design of the device of the invention was the simplicity of this fixation. In fact, the simplicity of the retained solutions must guarantee their reliability during their use on the machining machine tool.

According to a particularly advantageous feature of the invention, the conduit is constituted by a sleeve concentrically placed around the tool at the axis of rotation of the latter on its standard attachment support. This conduit is interiorly laid out with a groove in which is placed an elastic ring cooperating with the groove laid out to the end on the standard attachment support of the tool.

The fixation envisioned by the applicant does not require the changing of the standard tool supports already existing but simply an easy adaptation to carry out since it is a matter of realizing a groove subject to receive an elastic ring of the “circlips” type. In addition, the mounting in itself of the conduit around the tool does not require an particularly difficult installation as it simply requires the implementation of a circlips to enable the penetration of the standard attachment support in the interior of the conduit and its relaxation once the interior surface of the “circlips” is in the interior of the groove provided for this purpose in the support. Furthermore, the realization of such a groove does not require the modification of the functional surfaces already used.

The simplicity of this type of fixation of the mounting has the advantage to offer an attractive cost and to not create a cumbersome volume around the tool, volume that could limit the movements of the tool in the interior of the machining station. Furthermore such a solution avoids an overly large addition of mass to actuate at the tool. In fact, the rolling of the prior art and the parts required by its installation, defined a particularly large volume around the tool, volume or encumbrance that made the storage of the tools difficult in the traditional storage means.

An other advantage of the reuse of the support attachment of the tool resides therefore in the possibility to keep the existing interfaces such as that used between the tool and the tool holder module or that used between the tool and the possible storing module.

According to another particularly advantageous feature of the invention, the device is equipped with a means of angular indexing enabling the conduit to present an angular position suitable for its installation in the tool holder module in order that the part installed with the tool of the suction device itself presents and angular orientation sufficient to enable its placement in position and its maintenance in position with respect to the tool holder module.

The applicant also conducted research studies in order to optimize the setting in place of the individual incorporated part to each tool of the suction device on the fixed common part or the tool holder module. Thus, according to a particularly advantageous feature of the invention, the aforementioned conduit integral with the tool is set in place on the tool holder module during the relative movement of the tool with respect to the tool holding module corresponding to that known for the intake of the tool into the aforementioned tool holder module without supplemental action. Consequently, the placement in position and the maintenance in position of the suction device of the invention do not require supplemental action(s) with respect to the those already existing in the context of tool changing.

The fundamental concepts of the invention have just been explained above in their most elementary form. Other details and features will reemerge more clearly at the reading of the description corresponding to the annexed drawings that present, by way of non-limiting example, an implementation mode of the suction device in keeping with the invention.

### BRIEF DESCRIPTION OF THE DRAWINGS

FIG. 1 is a cross sectional, perspective view schematic drawing of an implementation mode of the device of the invention,

FIG. 2 is a perspective view schematic drawing of a typical unit aggregating a tool and a standard attachment support designed to receive the embarked part of the invention.

FIG. 3 is a cross-sectional view schematic drawing of the single incorporated part of the device of the invention.

FIG. 4 is a perspective view schematic drawing of the mounting operation on the tool holder module of the tool equipped with the device of the invention and in contact with a gripping means,

FIG. 5 is a side view schematic drawing of the implementation mode of the device of the invention, and

FIGS. 6a, 6b and 6c are cross-sectional view schematic drawings illustrating the different mounting stages of the tool and of the incorporated part of the device on the tool holder module.

### DESCRIPTION OF PREFERRED IMPLEMENTATION MODES

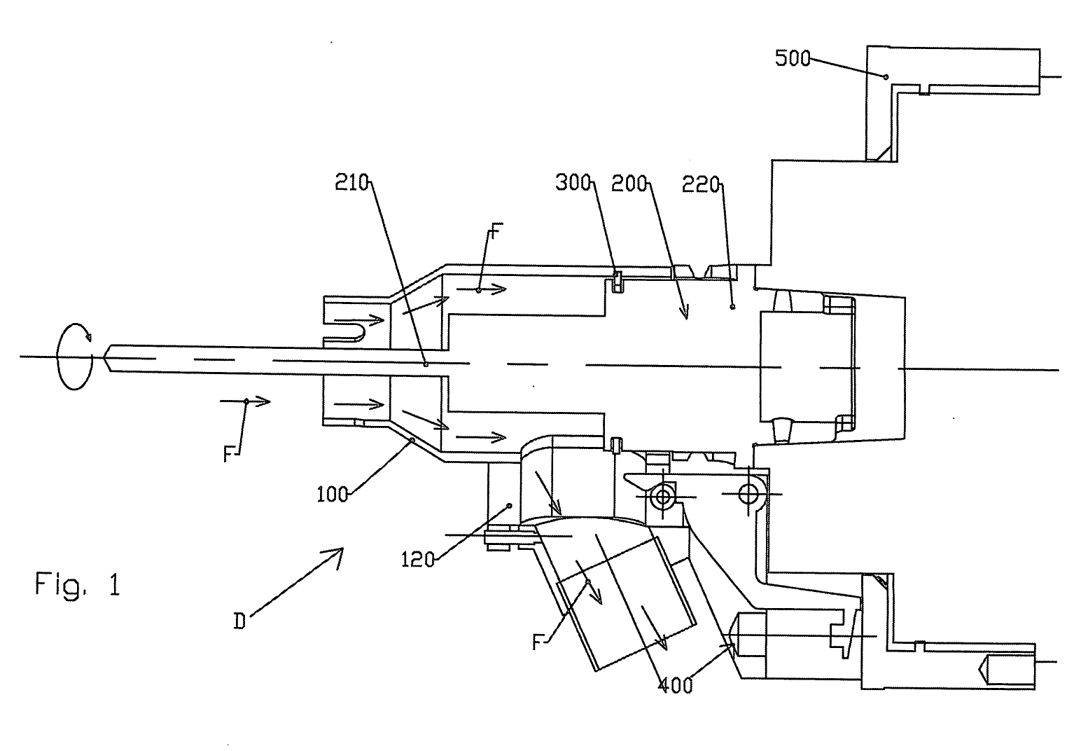

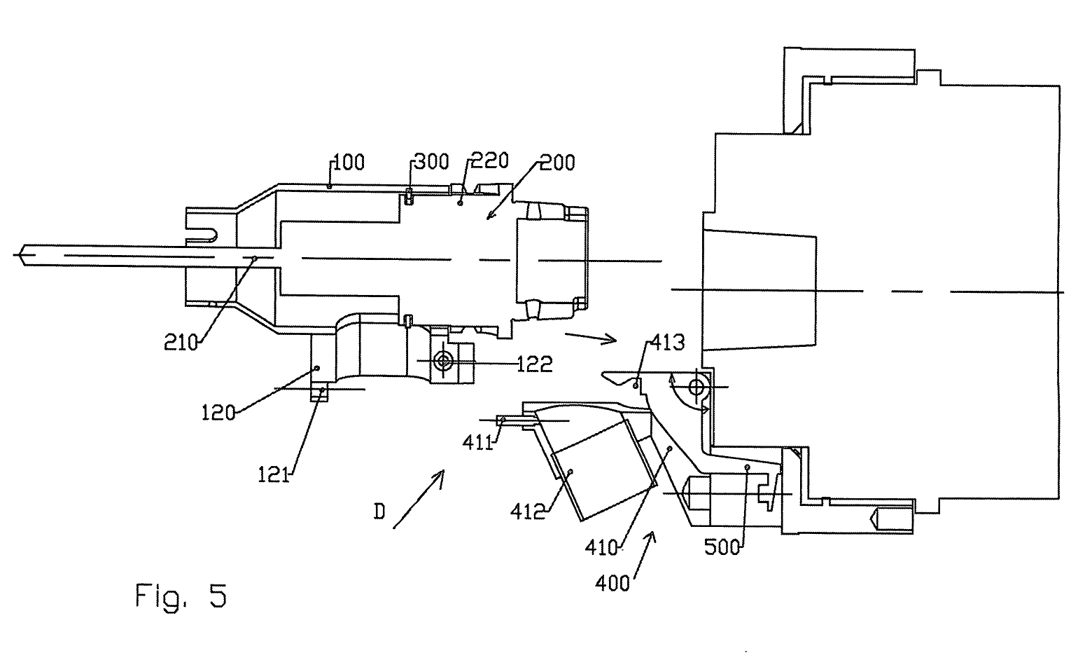

As illustrated on the drawings of FIGS. 1, 3, 4, 5 and 6, the device for suction of shavings, referred to as D in its entirety, is of the type comprising a suction unit (not illustrated) generating a low pressure and coupled to a suction conduit 100 coming as close as possible to the working end of a tool 200 actuated by a tool holder module of a machine tool (not illustrated), the tool 200 being composed of a cutting part 210 fixed on a standard attachment support 220.

According to the invention, the suction conduit 100 is fixed in a floating manner to the standard attachment support 220 of the tool 200, in a manner to generate a low pressure around the tool 200 while enabling the rotation of the latter. The movement of the air is illustrated by the arrows F. Thus, once the tool 200 and the conduit 100, incorporated part of the suction device D set in position there is a functional play between the inner surface of the conduit 100, which is fixed, and the outside surfaces of the tool 200 and of the attachment support 220, which are mobile according to a rotational movement around the axis of the tool 200.

In fact, the keeping of a fixed side between the tool and the conduit is only necessary during the machining operation. Therefore the invention includes an accurate positioning of the conduit with respect to the tool when the latter is installed in the tool holder module. The technological solution offered by the applicant thus enables the function of an accurate positioning between the conduit and the tool while they are installed on the actuation module of the tool. The absence of guiding reduces the cost, the bulk, and the mass of the elements to be actuated and the number of modifications to carry out on the existing installations.

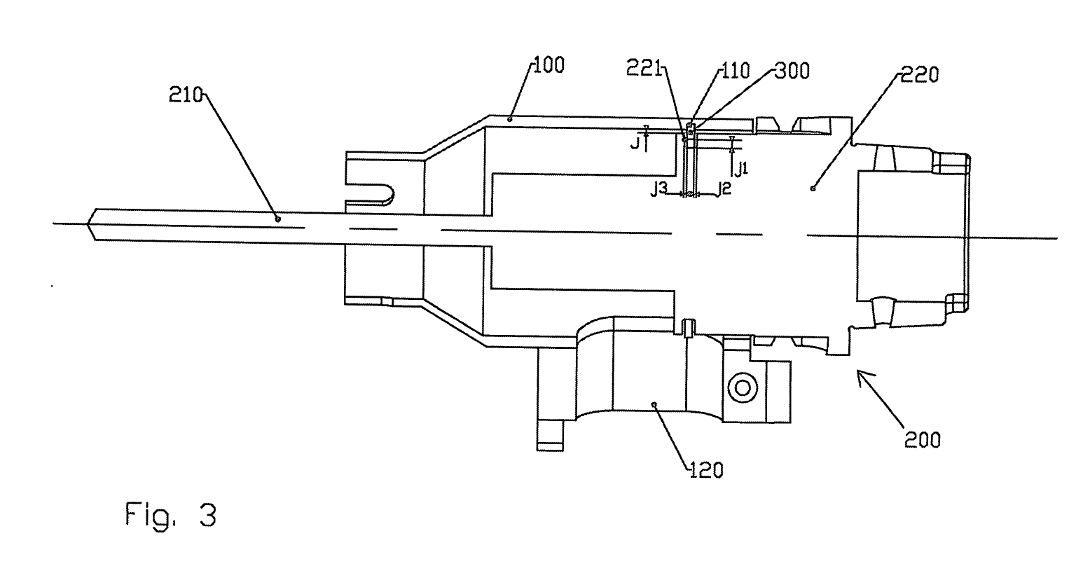

As illustrated in a more detailed manner on the drawing of FIG. 3, the conduit 100 is constituted in its rear part by a sleeve placed concentrically with respect to the rotational axis of the tool 200 on its standard attachment support 220.

According to a non illustrated feature, the aforementioned conduit 100 is extended at its front part by a conduit having a length adapted to the length of the tool 200 coming into contact with the piece to be machined (not illustrated), the length of which is subject to vary according to the axial movement of the tool 200.

In addition, the conduit 100 is interiorly arranged with a first groove 110 at the sleeve, in which is placed an elastic ring 300 of the “circlips” type cooperating with a second groove 221 arranged to that purpose on the standard attachment support 220 of the tool 200.

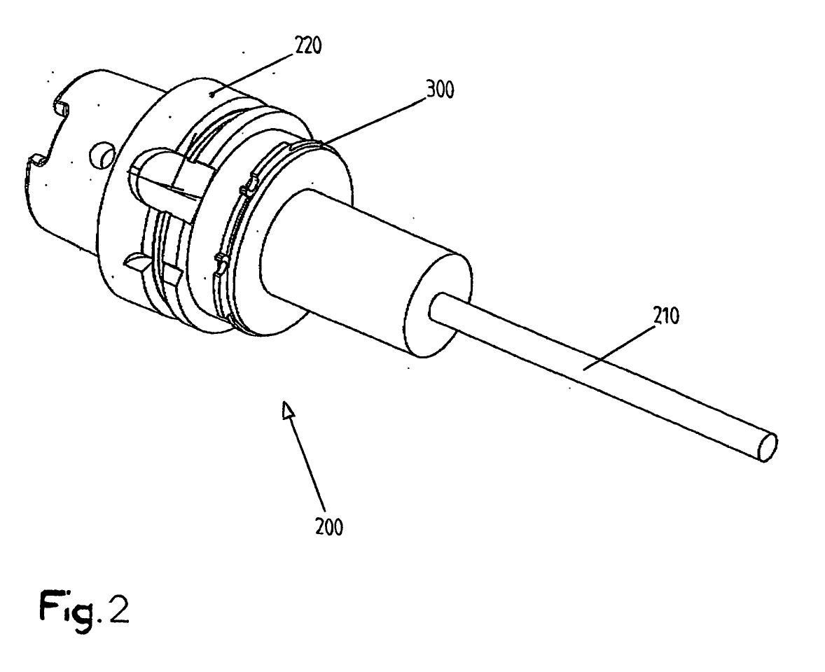

This groove 221 and the implantation of the elastic ring 300 within it appear in exterior view on the drawing of FIG. 2. According to the illustrated implementation mode, the standard attachment support 220 is of the HSK type and incorporates on its front part a cylindrical surface in which the groove 221 has been arranged. The solution chosen for the fixing of the conduit not only allows using already existing tool support devices but also requires only a minimal arrangement of the already existing devices. According to a preferred implementation mode, the elastic ring 300 is of the type of those remaining open at rest.

The mounting in itself is particularly simple.

It is sufficient to glide the tool 200 and its attachment support 220 with the elastic ring 300 maintained in closed position in the sleeve forming the rear part of the conduit 100 until the circlips 300 is set in place in the corresponding groove of the sleeve, in which it again resumes its resting position.

According to a particularly advantageous feature of the invention, the elastic ring 300 is mounted with play on the groove 221 arranged on the tool attachment support 220 so that, once set in place in the groove 110 of the conduit 100 and the conduit is coupled to the fixed part of device D, the ring is not in contact with the tool attachment support 220. Thus, as illustrated in FIG. 3, once set in place on the integral fixed part of the tool holder module, the elastic ring 300 is not in contact with the aforementioned groove 221 while maintaining a play represented by the marks J1, J2 and J3.

In fact, the function of this mounting is not to realize a tight fastening or a rotational guidance between the conduit 100 and the tool 200 but to avoid the disengagement of the standard fixing module 220 from the conduit 100, while allowing the rotation of the tool 200 when the latter is actuated by its pin.

As illustrated, the simplicity of this mounting has the advantage of not creating an overly bulky volume around the tool and thus in the machining station. In addition, this simplicity of implementation guarantees the reliability of such a technological solution. Thus, according to the illustrated implementation mode, the conduit does not present a thickness superior to the maximum diameter of the illustrated HSK tool attachment support. Consequently, the assembly formed by the tool coupled to the conduit requires a space management during the phases of machining, tool changing and tool storage, equivalent to that necessary for a tool, not being equipped with such a suction device.

As explained above, the device D is constituted by a first part, called incorporated, composed of a plurality of individual conduits 100 associated with each tool 200 and a second part fixed with respect to the tool holder module, which can be composed of a sliding pin holder providing the actuation not only in rotation of the tool but also possibly in translation according to the traditional axes X, Y and Z.

More specifically, the aforementioned conduit 100 integral with the movements of the tool 200 is coupled with the tool 200, via the actuation module of the latter, which includes a means 400 of setting in position and a means of maintaining in position of the latter having the function of coupling it to the suction unit (not illustrated) and to maintain it in a position so as not to interfere with the rotation of the tool 200.

According to a particularly advantageous feature of the invention, the aforementioned conduit 100 includes a conduit end 120 cooperating, once the tool 200 is set in its actuation module 500, with an end of another conduit coupled to the means of setting in position and maintaining in position.

According to another particularly advantageous feature of the invention, in order to implement the setting in position and the maintenance in position of the conduit 100, the fixing means 400 of the tool 200 that also receives the conduit 100 includes a principal body 410 that provides the coupling of the fixed part of the device D with the tool holder module 500.

This principal body is equipped with a common fixed adaptor that is placed opposing an incorporated adaptor corresponding to the conduit 100, during the intake of the tool 200 by the tool holder module 500, this common adaptor being also equipped with an end 412 of the conduit intended to be connected to the suction unit (not illustrated).

This adaptor includes a centering slug 411 associated with a blocking spur 413 that provides the positioning and maintenance in position of the conduit 100 in the appropriate position around the tool 200 when it is in position in the tool holder module 500 in a manner such that a play is present between the interior surface of the conduit 100, which remains fixed with respect to the tool support module and exterior surface of the attachment support of the tool 220 that is in rotation during the machining operation. In addition, the plays are calculated in a manner such that the “circlips” does not come in contact with the attachment support of the tool in the interior of the groove.

These fixed elements are coupled on the incorporated part in the centering hole 121 intended to receive the slug 411 and in a roller for guiding/blocking 122 that recaptures the spur 413.

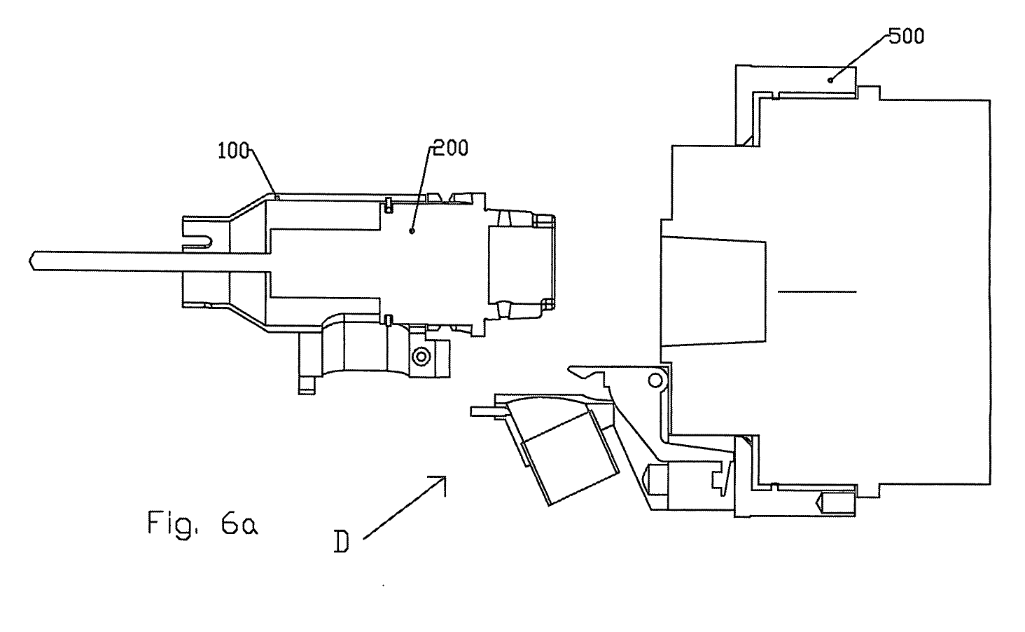

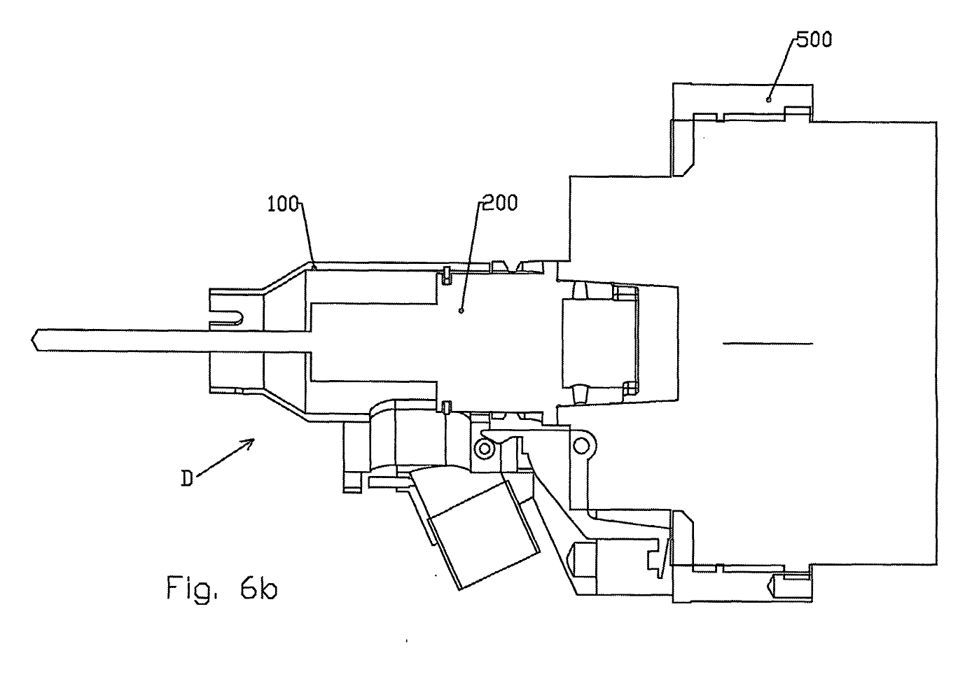

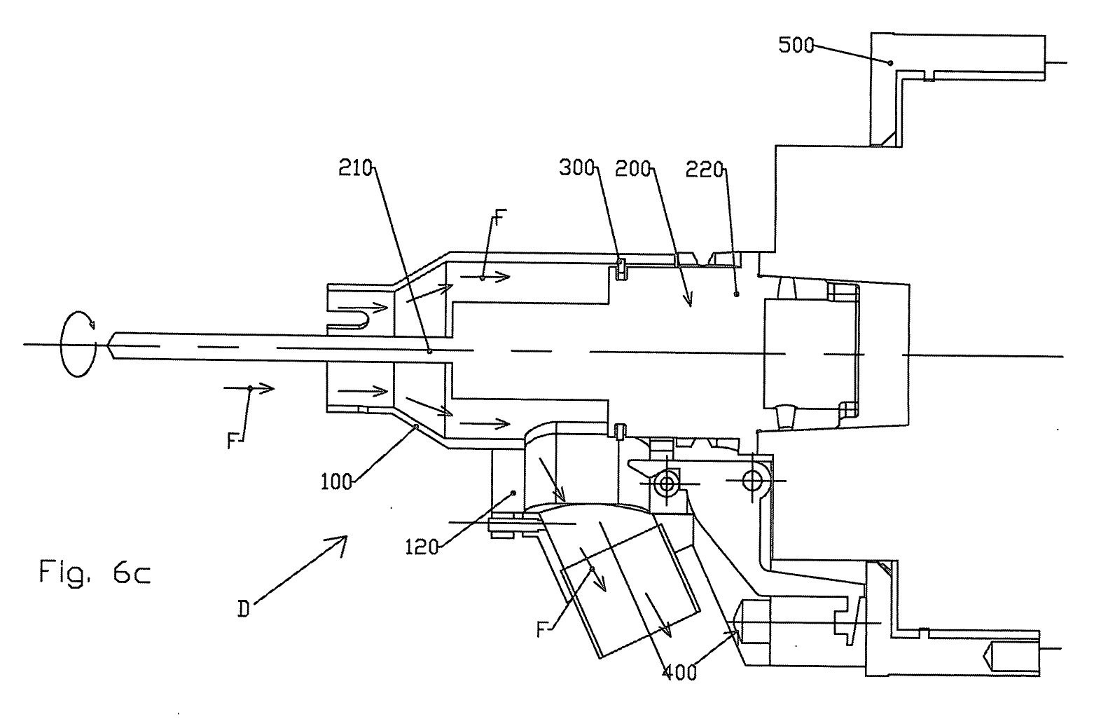

FIGS. 6a, 6b, and 6c illustrate the setting in position of the tool 200 coupled to its conduit 100 on the tool holder module 500. As illustrated, the end of the conduit 120 incorporated with the conduit 100 corresponds to the end of the fixed conduit 412 coupled to the suction unit (not illustrated) in a manner such that it creates a continuity in the suction conduit.

The choice of the means for setting position and for maintaining in position enables the suction device to not require a supplemental action or supplemental cycle time for its installation. In fact, the installation of the suction device, i.e. the jointure of the incorporated part with the fixed part is carried out in the same operation and thus in the same cycle time as the operation of taking the tool by the piece holding module.

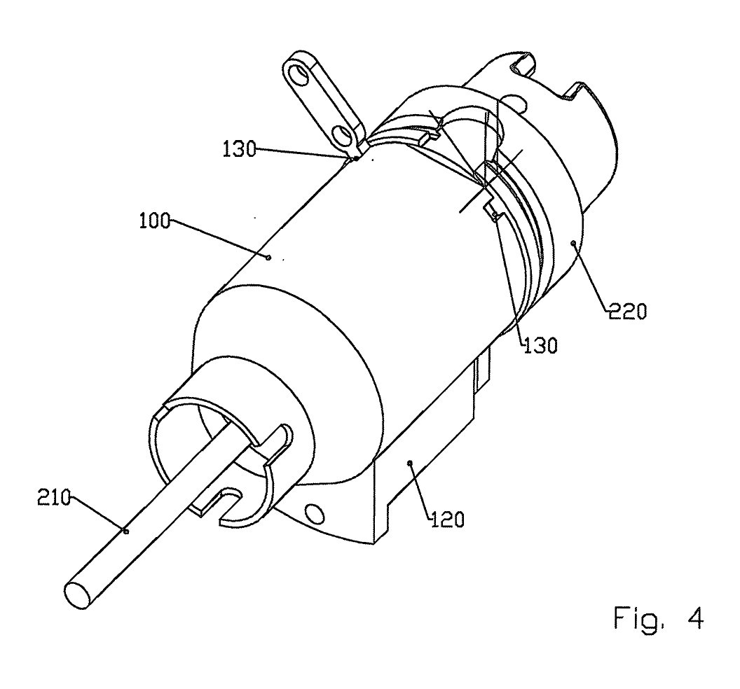

As illustrated on the drawing of FIG. 4, the aforementioned conduit 100 includes on the exterior notches 130 cooperating with the means for receiving or for gripping of the tool 200 during the phases of changing of the tool and of storing in order to correctly orient the end of the conduit that it includes.

According to a particularly advantageous implementation mode, the ends of the “circlips” 300 are accessible through the opening formed by the end 120 of the incorporated conduit by the assembly formed by the tool 200 and the conduit 100. It thus suffices to bring together the ends of the “circlips” 300 to disengage it from the groove 110 laid out in the interior surface of the conduit 100 and to enable the removal of the attachment support of the tool 220 from the conduit 100. Thus, not only the mounting but also the demounting are operations facilitated by the technological solution implemented by the device of the invention.

One understands that the suction device, that has just been described and represented above, was with a view to a disclosure rather than a limitation. Of course, various arrangements, modifications and improvements can be applied to the example above without departing from the framework of the invention as defined in the claims. Thus, for example, although particularly adapted to machining operations involving micro-pulverization, the device of the invention can be used in the context of machining operations involving traditional evacuation means.

1. A suction device for shaving products by a machining machine tool by means of a tool actuated by a tool holder module,
the device including a suction unit generating a low pressure,
the tool including a cutting part and a standard attachment support, characterized by the fact that it includes a suction conduit that is coupled
in a floating manner to the standard attachment support of the tool in a manner to generate a low pressure around the tool up to its end, and
in a manner fixed and precise, to the tool holder module in a manner to position the conduit with respect to the tool by creating a play between the conduit and the tool and to thus enable the rotation of the tool with respect to the conduit.

2. The device according to claim 1, characterized by the fact that the conduit is constituted on its rear part by a sleeve being placed concentrically at the rotational axis of the tool on its standard attachment support.

3. The device according to claim 1, characterized by the fact that the conduit is interiorly arranged with a first groove in which an elastic ring is placed, cooperating with a second groove arranged to this effect on the standard attachment support of the tool.

4. The device according to claim 3, characterized by the fact that the elastic ring is mounted with play on the groove arranged on the standard attachment support so that once set in place in the groove of the conduit and that the conduit is associated with a fixed part of the device, the ring is not in contact with the attachment support of the tool.

5. The device according to claim 1, characterized by the fact that the aforementioned conduit integral with the tool is coupled to the latter, by an actuation module of the tool including a means of placing in position and a means of maintaining in position having the function of coupling it to the suction unit and to maintain it in a position such that it does not interfere with the rotation of the tool.

6. The device according to claim 1, characterized by the fact that the aforementioned conduit integral with the tool is placed in place on the tool holder module when the relative movement of the tool with respect to the tool holder module corresponding to that known for the intake of the tool into the aforementioned tool holder module without supplemental action.

7. The device according to claim 5, characterized by the fact that the aforementioned conduit includes a conduit end cooperating, once the tool is set in place in its actuation module, with an end of another conduit coupled to a means of setting in position and maintaining in position.

8. The device according to claim 1, characterized by the fact that the tool holder module that also receives the conduit, is equipped with a common fixed adapter that is placed opposing a corresponding incorporated adapter for the conduit during the taking of the tool by the tool holder module, this fixed adapter being equipped with the end of the conduit intended to be connected to the suction unit.

9. The device according to claim 8, characterized by the fact that the fixed adapter includes a centering slug coupled to a blocking spur that provides the positioning and maintenance in position of the conduit in the appropriate position around the tool when it is in position in the tool holder module, these elements being coupled on the incorporated part with an incorporated adapter including a centering hold intended to receive the plug and of a guiding blocking roller that retakes the spur.

10. The device according to claim 1, characterized by the fact that the aforementioned conduit exteriorly includes notches cooperating with the means of receiving and of gripping of the tools during the phases of changing of the tool in order to correctly orient the end of the conduit that it includes.
